(19) United States
(12) Patent Application Publication
(10) Pub. No.: US 2025/0266743 A1
(43) Pub. Date: Aug. 21, 2025

(54) Non-contact magnetically suspended hair clipper

(71) Applicant: Yuyao Hengchi Electric Appliance Co., Ltd, Ningbo (CN)

(72) Inventor: Shengnong LU, Ningbo (CN)

(73) Assignee: Yuyao Hengchi Electric Appliance Co., Ltd, Ningbo (CN)

(21) Appl. No.: 18/928,568

(22) Filed: Oct. 28, 2024

(30) Foreign Application Priority Data
Feb. 20, 2024 (CN) 2024203088460

(51) Int. Cl. H02K 33/16; B26B 19/28; H02K 11/33

(52) U.S. Cl. CPC H02K 33/16; B26B 19/28; H02K 11/33; H02K 2211/03

(57) ABSTRACT

The present invention relates to the technical field of hair clippers, specifically a non-contact magnetically suspended hair clipper, comprising a casing, a control circuit board, a magnetic core and an oscillating part, at least one coil is installed in the magnetic core, an end of the at least one coil is connected with the control circuit board, a rotation shaft is installed in between the oscillating part and the casing, a cutter assembly is connected at an end of the oscillating part, at least one magnet set is installed at another end of the oscillating part, and a gap is configured in between the at least one magnet set and the at least one coil.

### INCORPORATION BY REFERENCE

This application claims the benefit of priority from China Patent Application No. 2024203088460 filed on February 20 2024, the contents of which are hereby incorporated by reference in their entirety.

### TECHNICAL FIELD

The present invention relates to the technical field of hair cutters, specifically a non-contact magnetically suspended hair clipper.

### BACKGROUND TECHNOLOGY

At present, during use of a hair clipper, it is necessary to move reciprocally the cutter for cutting the hair in high frequencies, which is done by a motor and a transmission structure, earlier, the transmission structure is configured usually as a motor driving high speed revolution of an eccentric wheel, the eccentric wheel is connected at an end of the cutter base so as to drive the cutter to move reciprocally in high frequencies, due to the use of the eccentric wheel drive structure, a bigger housing cavity is required in the casing of the hair clipper, consequently, an end of the hair clipper neighboring the hair cutter has to be designed to be large, which as a result makes a volume of the hair clipper big.

In view of this, those skilled in the art proposed a brushless electromagnetically suspended vibration motor, for example, as disclosed in the Chinese invention patent publication no CN114123702B, a brushless electromagnetically suspended vibration motor, comprising a support, a coil fixing base is fixed at a top portion of the support, a stator coil and a stator are provided respectively in the coil fixing base, the stator coil is wound around the stator, the top portion of the stator is exposed out of the top portion of the coil fixing base, metal domes are provided at both sides of the support, and the coil fixing base and the metal domes are jointly connected with the magnetically alternately moving module.

As the oscillating magnitude of the motor is subjected to limitation of deformation of the metal domes, the oscillating rate is low, the oscillating magnitude is small, further improvements are required for the structure.

### SUMMARY OF THE INVENTION

The present invention aims to provide a non-contact magnetically suspended hair clipper, and address the problem of the small oscillating magnitude.

The present invention is realized in this way: a non-contact magnetically suspended hair clipper, comprising a casing, a control circuit board, a magnetic core and an oscillating part, at least one coil is installed in the magnetic core, an end of the at least one coil is connected with the control circuit board, a rotation shaft is installed in between the oscillating part and the casing, a cutter assembly is connected at an end of the oscillating part, at least one magnet set is installed at another end of the oscillating part, and a gap is configured in between the at least one magnet set and the at least one coil.

Preferably, a number of the at least one coil is configured to be at least one, a number of the at least one magnet set is configured to be at least one, and the number of the at least one coil and the number of the at least one magnet set are the same.

Preferably, an installation hole for installing the rotation shaft is opened in the oscillating part, and a shaft sleeve is provided in between the rotation shaft and the installation hole.

Preferably, the rotation shaft is transversely provided in the casing, two supporting plates are provided in the casing, and a first installation groove for installing the rotation shaft is respectively formed in the two supporting plates.

Preferably, the rotation shaft is vertically provided in the casing, two installation cylinders are provided in the casing and a second installation groove is respectively opened in the two installation cylinders.

Preferably, a spring is installed in between the oscillating part and the body.

Outstanding and beneficial technical effects relative to the prior art are:

In the present invention, by designing the rotation shaft to limit the movement position of the oscillating part to move in a certain range, during actual work, the at least one coil is energized and alternating the current directions periodically, the electromagnetic field with alternating magnetic poles generated by the magnet cores interact with the magnetic field of the at least one magnet set of the oscillating part, so that the oscillating part makes reciprocal movement around the rotation shaft, and drives the cutter assembly to cut the hair.

### BRIEF DESCRIPTION OF DRAWINGS

FIG. 1 is a structural diagram showing the present invention.

FIG. 2 is a second structural diagram showing the present invention.

FIG. 3 is a second structural diagram showing the present invention.

FIG. 4 is a structural diagram showing at least one magnet core, at least one coil and an oscillating part.

FIG. 5 is a structural diagram showing installation of the oscillating part.

FIG. 6 is a second structural diagram showing installation of the oscillating part.

Markups in the drawings are: 1 casing; 2 control circuit board; 3 magnet core; 4 oscillating part; 5 coil; 6 rotation shaft; 7 cutter assembly; 8 magnet set; 10 insertion part; 11 installation hole; 12 shaft sleeve; 13 supporting plate; 14 first installation groove; 15 installation cylinder; 16 second installation groove; and 17 spring.

### Embodiments

Hereinafter a further detailed description will be given to the embodiments of the present invention in conjunction with the drawings.

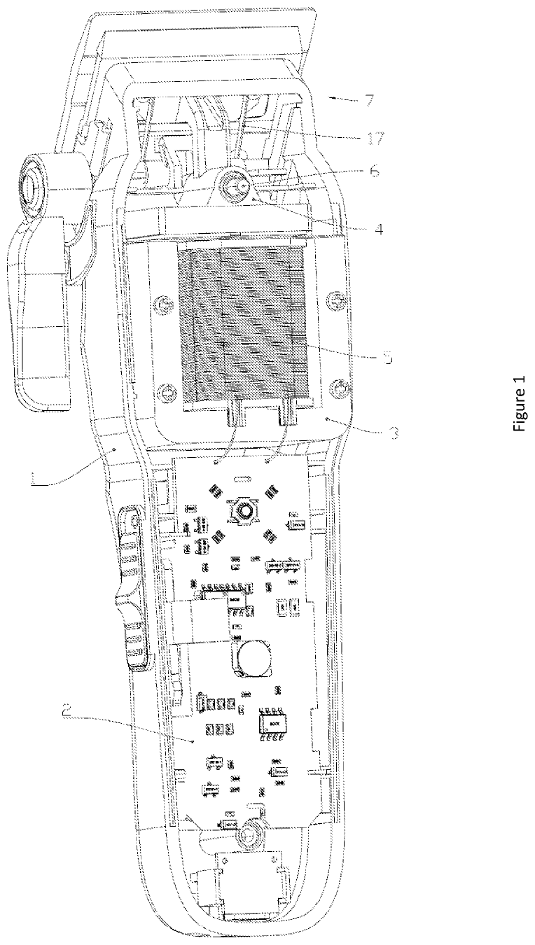

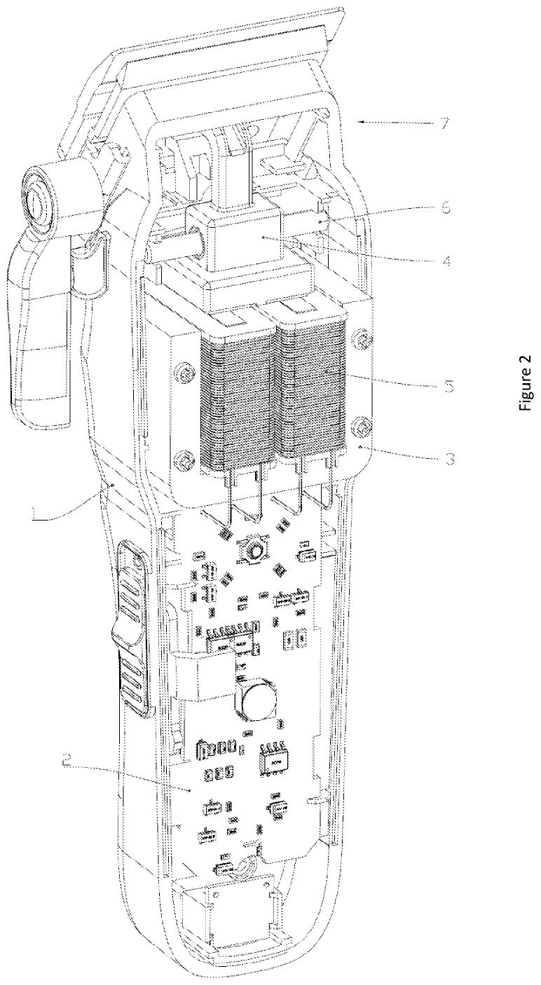

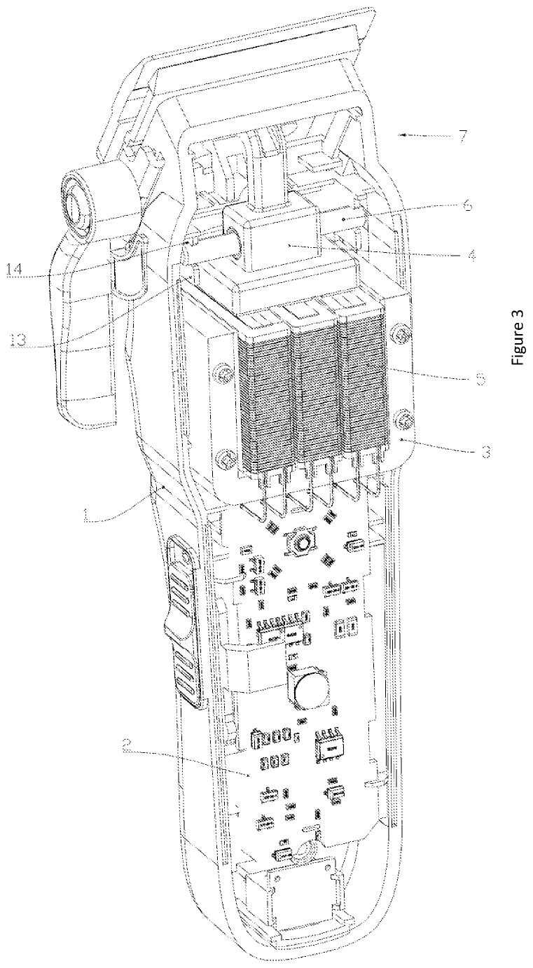

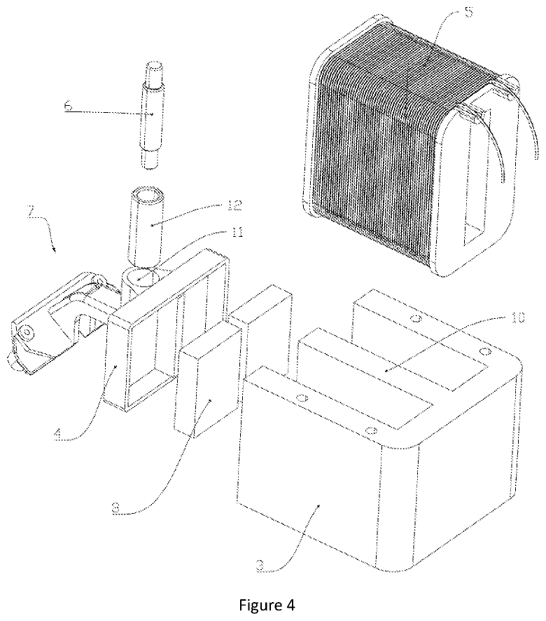

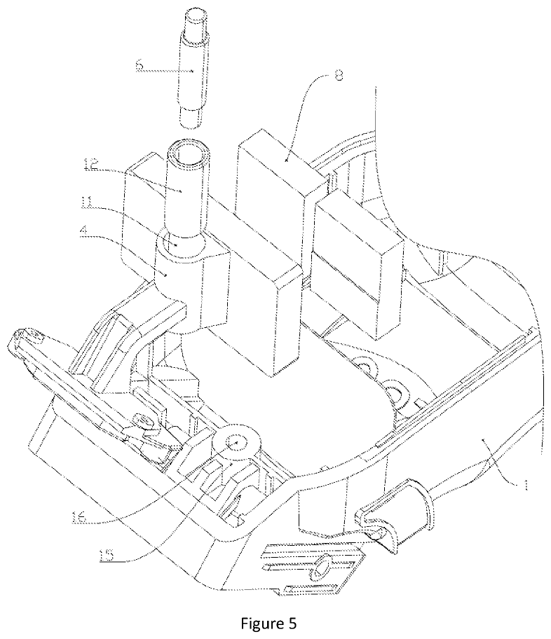

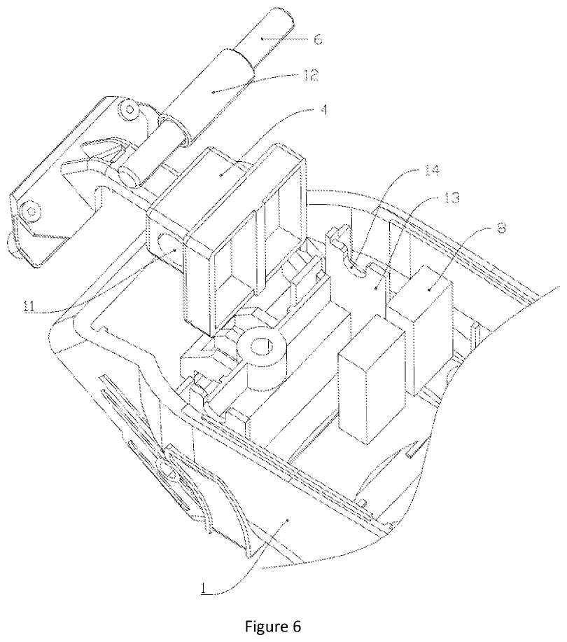

As shown in FIGS. 1-6, a non-contact magnetically suspended hair clipper, comprising a casing 1, a control circuit board 2, a magnetic core 3 and an oscillating part 4 are provided in the casing 1, either end of the at least one coil 5 are connected with the control circuit board 2, a rotation shaft 6 is installed in between the oscillating part 4 and the casing 1, a cutter assembly 7 is connected at an end of the oscillating part 4, at least one magnet set 8 is installed at another end of the oscillating part 4, and a gap is present in between the at least one magnet set 8 and the at least one coil 5.

In the present invention, by the design of the rotation shaft to limit the movement of the oscillating part 4, to move in a certain range reciprocally, during work, the at least one coil 5 is energized and changing current directions cyclically, an electromagnetic field with alternating magnetic poles generated by the at least one magnet core 3 interacts with a magnetic field of the at least one magnet set 8 of the oscillating part 4 to have the oscillating part 4 to make reciprocal movement around the rotation shaft 6, and drive the cutter assembly 7 to cut the hair.

In the present invention, by driving the cutter assembly 7 to operate by electromagnetic induction, therefore, during actual operation, as no complex mechanical structure is present in between the at least one magnet set 8 and the at least one coil 5, the structure is simple, the cost is low, a certain clearance is present in between the at least one magnet set 8 and the at least one coil 5, no contact occurs in between the two parts, no loss will occur due to long term use, the service life can be prolonged.

A shape of the magnet core 3 is U-shaped, a plug 10 is formed in the magnet core 3 for being inserted into the coils 5 to connect the at least one coil 5 and the magnet core 3.

A number of the at least one coil is at least one, a number of the at least one magnet set 8 is at least one, the number of the at least one coil 5 and the number of the at least one magnet set 8 are equal, in the present technical solution, the number of the at least one magnet set 8 and the at least one coil 5 can be one, two or three.

An installation hole 11 for installing the rotation shaft 6 is opened in the oscillating part 4, a shaft sleeve 12 is provided in between the rotation shaft 6 and the installation hole 11, friction in between parts can be reduced in this way to relieve wearing and extend usage time.

The rotation shaft 6 is transversely provided in the casing 1, two supporting plates 13 are provided in the casing 1, and a first installation groove 14 for installing the rotation shaft 6 is formed respectively in the two supporting plates 13.

The rotation shaft 6 is vertically provided in the casing 1, two installation cylinders 15 are provided in the casing 1, and a second installation groove 16 for installing the rotation shaft 6 is opened in the two installation cylinders 15.

The rotation shaft 16 is vertically provided in the casing 1, two installation cylinders 15 are provided in the casing 1, and a second installation groove 16 for installing the rotation shaft 6 is opened respectively in the two installation cylinders 15.

In the foregoing paragraphs, basic principles, main features and advantages of the present invention are set forth. Those skilled in the art shall understand that, the present invention is not subjected to limitation of the foregoing embodiments, only the principles of the present invention have been given in the embodiments and the description, without departing from the essence and range of the present invention, it is still possible to make a lot of variations and improvements to the present invention, which fall into the protection scope of the present invention. The protection scope of the present invention is defined by the appended claims and equivalents thereof.

1. A non-contact magnetically suspended hair clipper, comprising a casing, a control circuit board, a magnetic core and an oscillating part, at least one coil is installed in the magnetic core, an end of the at least one coil is connected with the control circuit board, a rotation shaft is installed in between the oscillating part and the casing, a cutter assembly is connected at an end of the oscillating part, at least one magnet set is installed at another end of the oscillating part, and a gap is configured in between the at least one magnet set and the at least one coil.

2. The non-contact magnetically suspended hair clipper according to claim 1, wherein the magnetic core is U-shaped, and an insertion portion for inserting into the at least one coil is formed in the magnetic core.

3. The non-contact magnetically suspended hair clipper according to claim 1, wherein a number of the at least one coil is configured to be at least one, a number of the at least one magnet set is configured to be at least one, and the number of the at least one coil and the number of the at least one magnet set are equal.

4. The non-contact magnetically suspended hair clipper according to claim 1, wherein an installation hole for installing the rotation shaft is opened in the oscillating part, and a shaft sleeve is provided in between the rotation shaft and the installation hole.

5. The non-contact magnetically suspended hair clipper according to claim 1, wherein the rotation shaft is transversely provided in the casing, two supporting plates are provided in the casing, and a first installation groove for installing the rotation shaft is respectively formed in the two supporting plates.

6. The non-contact magnetically suspended hair clipper according to claim 4, wherein the rotation shaft is vertically provided in the casing, two installation cylinders are provided in the casing and a second installation groove is respectively opened in the two installation cylinders.

7. The non-contact magnetically suspended hair clipper according to claim 4, wherein a spring is installed in between the oscillating part and the body.
